(19) United States
(12) Patent Application Publication
(10) Pub. No.: US 2012/0095962 A1
(43) Pub. Date: Apr. 19, 2012

(54) Aggregating Media Content From Multiple Clients To A Server

(76) Inventors: Jason D. Goldman, Ft. Collins, CO (US); Anthony Joseph Hernandez, Westminster, CO (US); Allen O. Buckner, Loveland, CO (US); William Girard McCollom, Fort Collins, CO (US)

(21) Appl. No.: 13/119,132

(22) PCT Filed: Oct. 14, 2008
(86) PCT No.: PCT/US2008/079887

§ 371 Date: Nov. 16, 2011

(51) Int. Cl. G06F 17/30

(52) U.S. Cl. 707/634; 707/E17.005

(57) ABSTRACT

A data processing system aggregates media content from multiple clients to a server. The data processing system comprises a media manager that aggregates media content from a client of a plurality of clients onto a server. The media manager comprises a monitoring utility and a server media update utility. The monitoring utility periodically checks for media files that are newly added in a client library of the client plurality and/or scanned from client storage, and detects newly added media. The server media update utility determines whether the newly added media. The server media update utility determines whether the newly added media is present on the server and copies the newly added media to the server if the newly added media is not present on the server or a lower quality version of the newly added media is present on the server.

### BACKGROUND

A media center or media library is an application for usage as a home-entertainment hub. In a typical implementation, the media center enables access of a computer user's pictures, photographs, and music from local hard drives, optical drives, and network locations, and enables categorization of media items by name, date, tags, and other file attributes. Media managed through a media center can be relayed via a home network to standard television sets or music systems such as high fidelity systems of various types.

Typical media arrangements are managed by manual techniques with actions based on user interactions. Users can move media content files to a server, which can recognize the content. In a particular example, a user can take an iTunes library, that is specific to the user, and move the library to a server which is runs an application such as Digital Audio Access Protocol, for example MT-DAAP, which allows the server to act as an iTunes server, a simple case which really only works for a single user.

In another example, a user can simply move media files to the server and direct MT-DAAP to a location for finding a collection of songs. For multiple users, each user's collection of files are moved manually and, if the user decides to store each user's collection separated in different folders, then the storage and information redundancy issues are not addressed in any manner. Manual media consolidation has risks. Consolidation based on file name alone is not sufficient since such a technique does not guarantee that the media files contain the same content.

Using the typical techniques, migrating playlists to the server demands manual modification to enable reference to the new media file locations on the server in a manner similar to that of other file groupings such as photograph albums.

### SUMMARY

Embodiments of a data processing system aggregate media content from multiple clients to a server. The data processing system comprises a media manager that aggregates media content from a client of a plurality of clients onto a server. The media manager comprises a monitoring utility and a server media update utility. The monitoring utility periodically checks for media files that are newly added in a client library of the client plurality and/or scanned from client storage, and detects newly added media. The server media update utility determines whether the newly added media is present on the server and copies the newly added media to the server if the newly added media is not present on the server or a lower quality version of the newly added media is present on the server.

### BRIEF DESCRIPTION OF THE DRAWINGS

Embodiments of the invention relating to both structure and method of operation may best be understood by referring to the following description and accompanying drawings:

FIGS. 1A, 1B, and 1C are schematic block diagrams showing embodiments of data processing systems that aggregate media content from multiple clients to a server;

FIG. 2 is a schematic block diagram depicting an embodiment of network data processing system that aggregates media content from multiple clients to a server;

FIGS. 3A through 3G are flow charts illustrating one or more embodiments or aspects of a computer-executed method for aggregating media content from multiple clients to a server;

FIGS. 4A and 4B are flow charts showing one or more embodiments or aspects of a computer-executed method for handling media content and migrating media files;

FIG. 5 is a schematic block diagram depicting an embodiment of a media aggregation system; and

FIGS. 6A through 6F are flow charts illustrating one or more embodiments or aspects of a computer-executed method for executing aggregating synchronization on a client.

### DETAILED DESCRIPTION

Embodiments of systems and methods disclosed herein consolidate media data when aggregating from multiple clients and users to a single server.

A media-adapted server enables multiple users, for example in a household for a home server, to aggregate media data from multiple users and/or client systems. The aggregated media data is stored on the server, enabling users for access within the managed group or home.

Various systems and techniques are disclosed for organizing and consolidating the media files such that storage space is reduced or minimized and the user's visual “chatter” of redundant content is minimized.

In an example application, within a single household may be several personal computers (PCs) containing media files such as music or videos. Multiple users in the household may access the media files. Identical media files may be stored on several PCs. On a single PC, multiple users might each reference the same media source file, for instance music track file, within a media library such as iTunes. Media libraries can be source of media files and playlists to be aggregated onto the server, or media can be scanned from a client or user computer or system.

One consideration is that a simple approach to aggregating content from different users' media libraries may result in multiple copies of the same media files accumulating on and cluttering the server. Such redundancy wastes disk space on the server. A more important concern is that users browsing the server find multiple copies of exactly the same media file, a visual redundancy that can hinder the user in attempting to find and select desired content.

The illustrative systems and techniques address several technical considerations. Media file references are consolidated in media libraries that are mapped to the same specific file. Media files are recognized and consolidated that refer to the same content, taking into consideration that different files for the same media, for example music track, may have different levels of quality, for example audio quality. The depicted systems and techniques enable management and maintenance of play list content, for example media file references, after consolidating media files and moving the files to the server. Additionally, the server enables the user to reduce the view of the media content to the specific user's files.

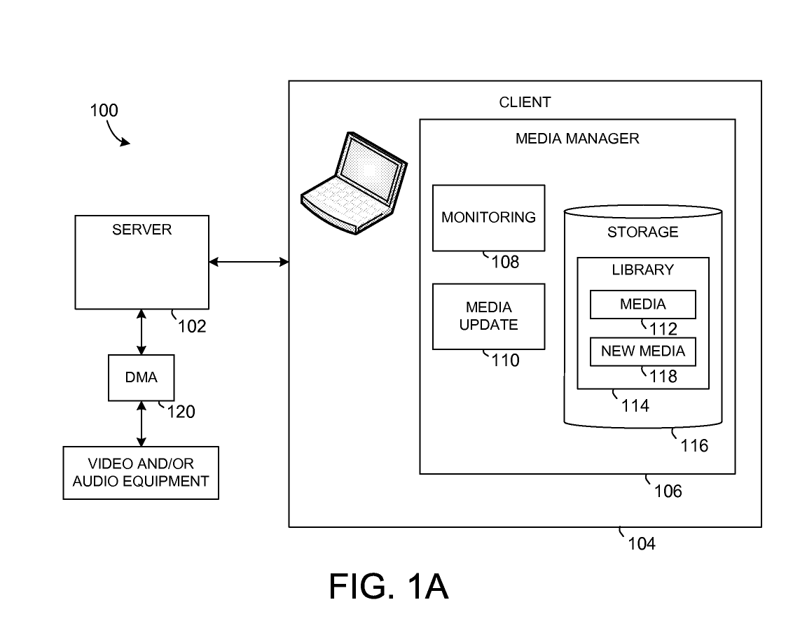

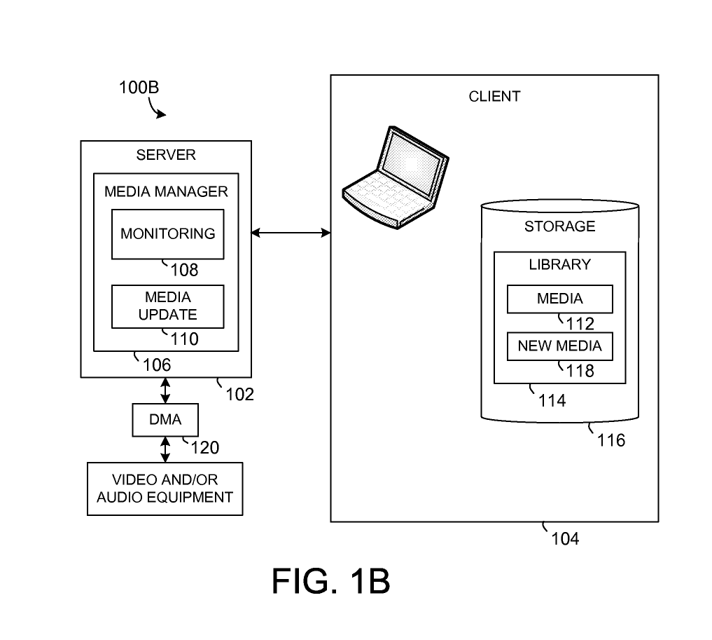

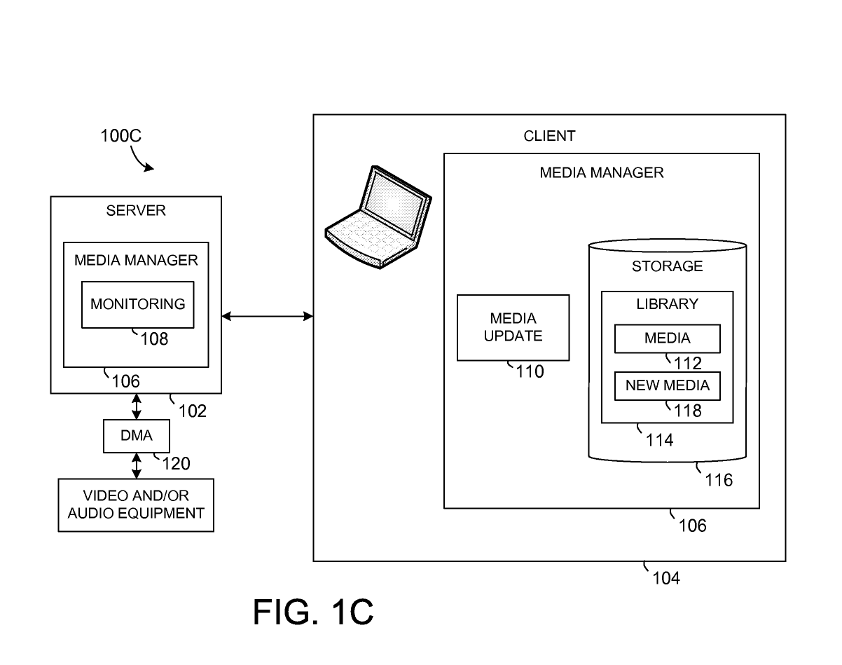

Referring to FIG. 1A, a schematic block diagram illustrates an embodiment of data processing system 100 that aggregates media content from multiple clients 104 to a server 102. The data processing system 100 comprises a media manager 106 that aggregates media content from a client of multiple clients 104 onto the server 102. The media manager 106 comprises a monitoring utility 108 and a server media update utility 110. The monitoring utility 108 periodically checks for media files 112 that are newly added in a client library 114 of the multiple clients 104 and/or scanned from client storage 116, and detects newly added media 118. The server media update utility 110 determines whether the newly added media 118 is present on the server 102 and copies the newly added media 118 to the server 102 if the newly added media 118 is not present on the server 102 or a lower quality version of the newly added media is present on the server 102.

In the illustrative embodiment, the media manager 106 is executable on the client of multiple clients.

Digital Media Adaptors (DMAs) 120 such as Roku SoundBridge can connect to the server 102 to enable access to the aggregated data.

Referring to FIG. 1B, a schematic block diagram shows an embodiment of data processing system 100B that aggregates media content from multiple clients 104 to a server 102 wherein the media manager 106 is executable on the server 102.

Referring to FIG. 1C, a schematic block diagram depicts an embodiment of data processing system 100C that aggregates media content from multiple clients 104 to a server 102 wherein the media manager 106 is executable in part on the client 112 of multiple clients and executable in part on the server 102.

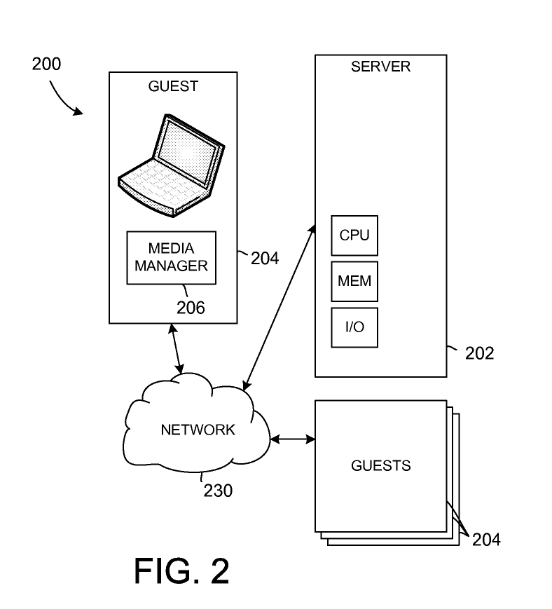

Referring to FIG. 2, a schematic block diagram shows an embodiment of network data processing system 200 that aggregates media content from multiple clients 204 to a server 202. The network data processing system 200 comprises a network 230, a server 202 coupled to the network 230, and one or more clients 204 coupled to the network 230. The server 202 and client or clients 204 are configured to run the media manager 206.

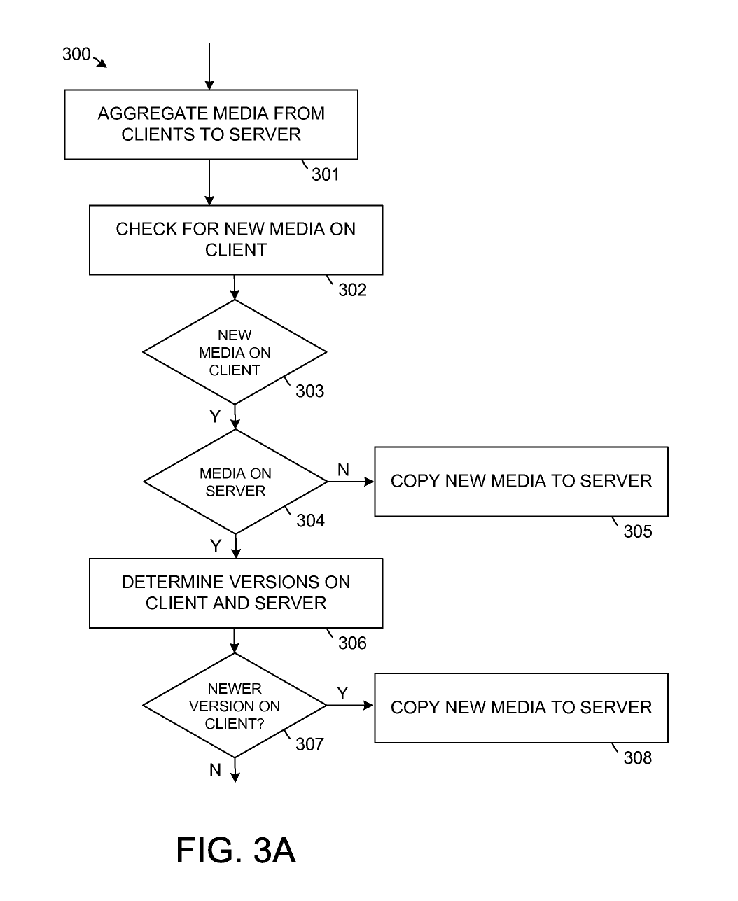

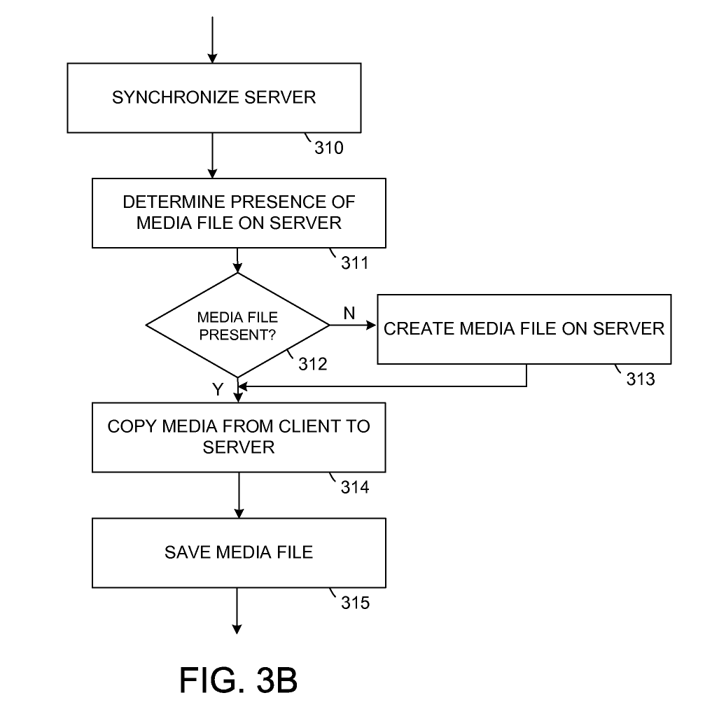

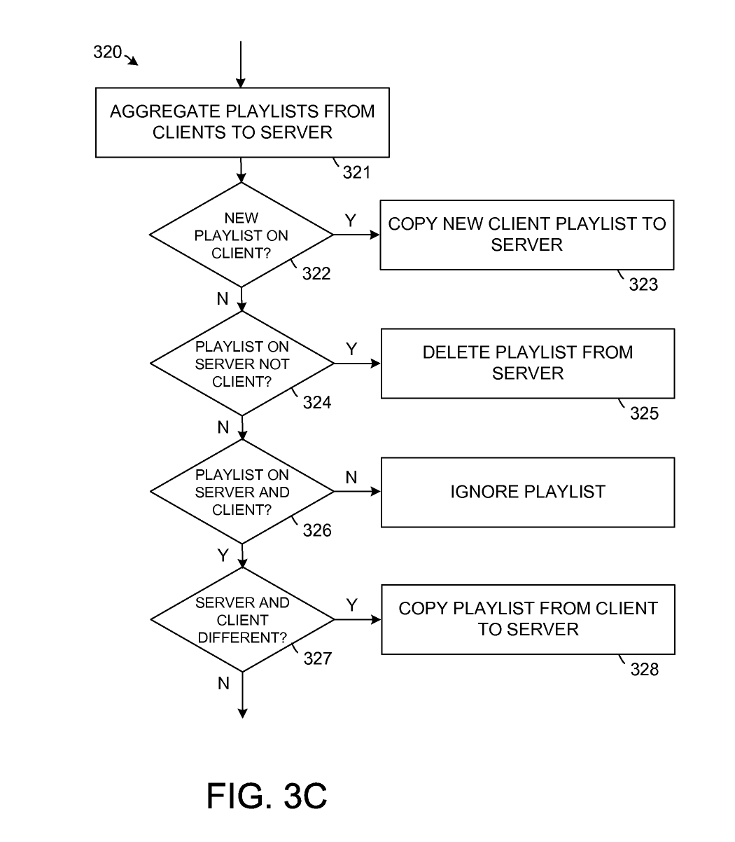

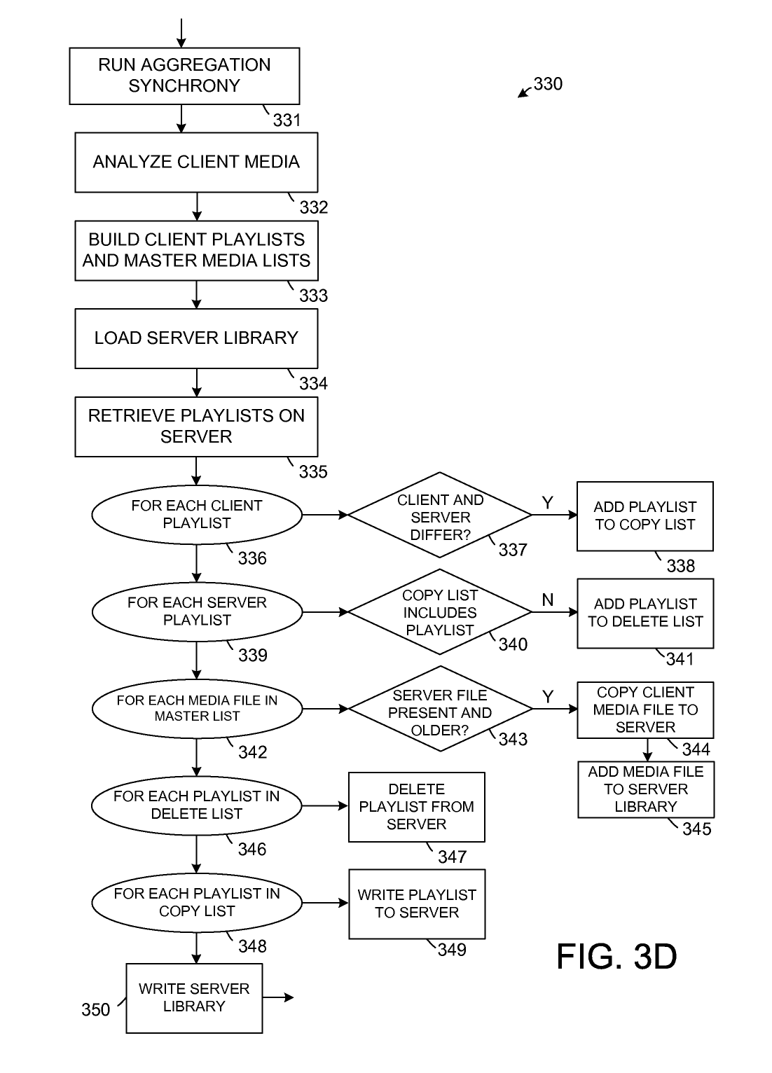

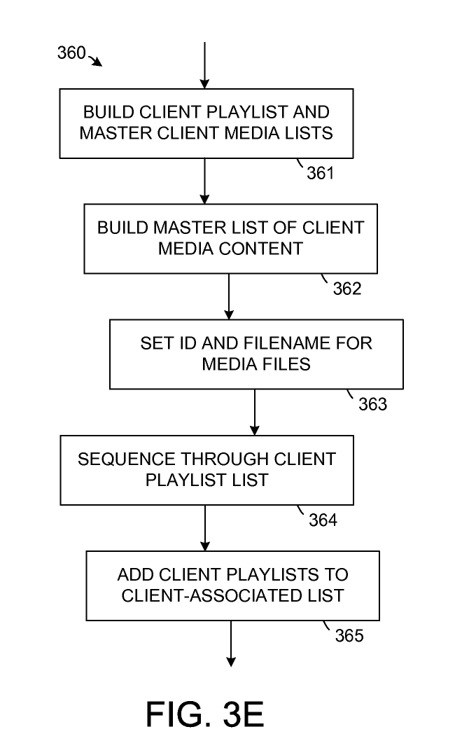

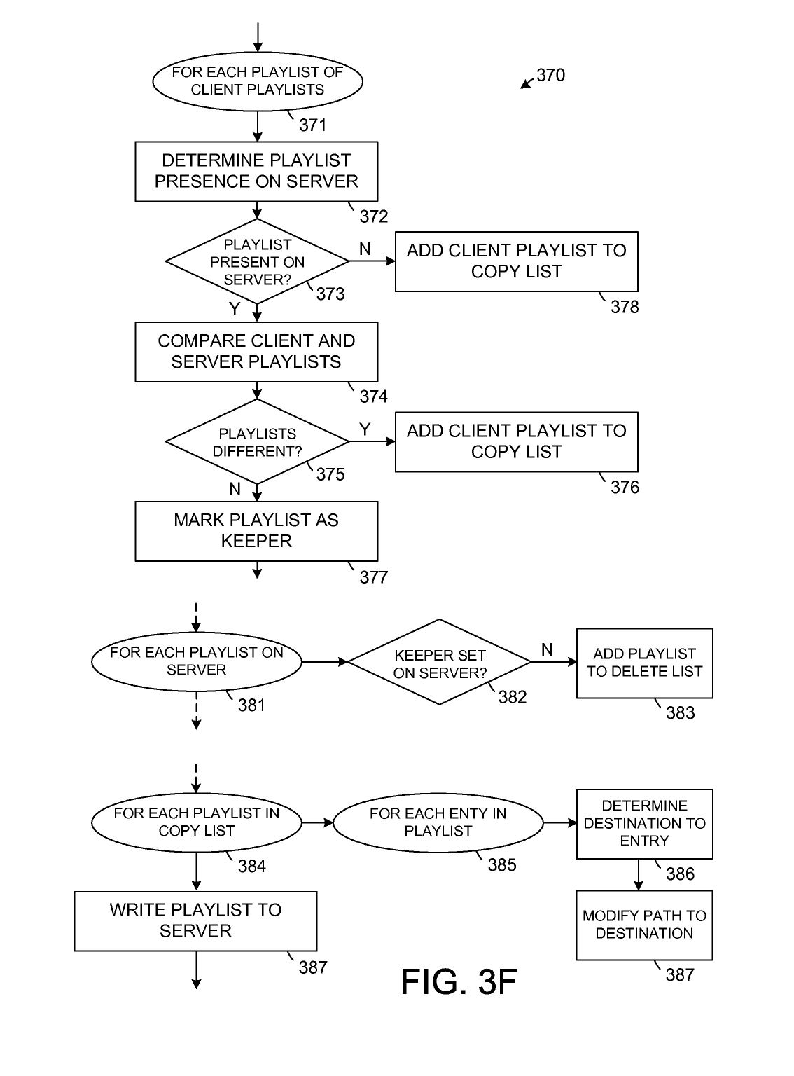

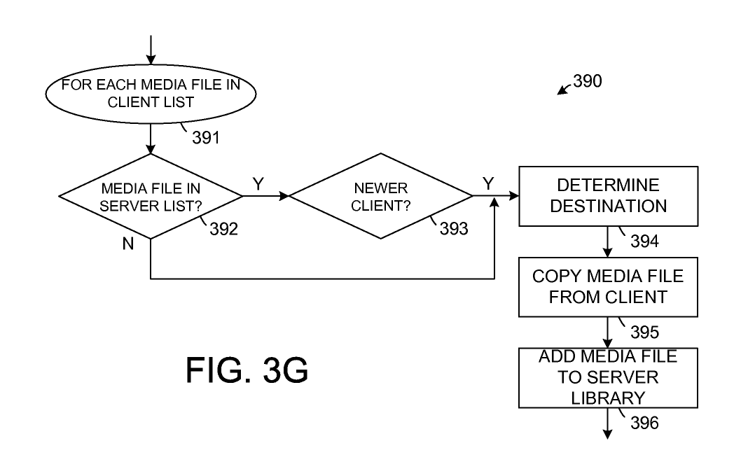

Referring to FIGS. 3A through 3G, flow charts illustrate one or more embodiments or aspects of a computer-executed method for aggregating media content from multiple clients to a server. FIG. 3A depicts a computer-executed method 300 for handling media content comprising aggregating 301 media content from a client of multiple clients onto a server. Aggregating 301 media comprises periodically checking 302 for media that is newly added in a client library or are scanned from storage of the client or clients. When newly added media is detected 303 on the client, presence of corresponding newly added media on the server is determined. If the newly added media is not present 304 on the server, the newly added media is copied 305 to the server. If the newly added media is present 304 on the server, whether the newly added media is a higher quality version in comparison to media on the server is determined 306. If the newly added media is a higher quality version 307, the higher quality version media is copied 308 to the server. Quality of a version can be based on various considerations. For example, a newer version may be considered to have a higher quality. Similarly, fidelity of the version can have a higher quality based on bit rate or other indicia. For example, a higher bitrate version can replace a lower bitrate version.

In some conditions or in some implementations, aggregating media content on the client plurality comprises reading a user's client library that lists media files and playlists. A playlist is a basis for organization in various media player software programs for usage in organizing and managing music on a personal computer. Playlists may be defined, stored, and selected to run in sequence or, if a random playlist function is selected, in a random order. Playlists enable creation and maintenance of a desired musical atmosphere with limited user interaction.

In some conditions or in some implementations, aggregating media content on the client plurality comprises scanning for content on a computer, for example from storage such as disk storage, Compact Disk-Read Only Memory (CD-ROM), Digital Versatile Disk (DVD), other forms of storage, and/or memory.

Referring to FIG. 3B, a computer-executed method for synchronizing 310 the server comprises determining 311 presence of a media file on the server. If the media file is not present 312, the media file that lists media and playlists which are loaded onto the server is created 313. The method 310 further comprises copying 314 media from the client to the server for media that are missing or lower quality version than media from the client, and saving 315 the media file.

Referring to FIG. 3C, in some embodiments an aspect 320 of the computer-executed method for handling media content can include aggregating 321 static, user-created playlists from the client of a plurality of clients onto the server comprising, for playlists existing in the client library and/or scanned from client storage that do not exist on the server 322, copying 323 the client playlist to the server. For playlists existing on the server that do not exist in the client library or are scanned from client storage 324, the playlist is deleted 325 from the server. For playlists existing on the server and in the client library and/or scanned from client storage 326, whether playlist content is different on the server and in the client library is determined 327. If the playlist content on the server and the client library and/or scanned from client storage are different 327, the playlist content from the client library and/or scanned from client storage is copied 328 to the server.

Referring to FIG. 3D, in some embodiments an aspect 330 of the computer-executed method for handling media content can include running 331 an aggregation synchrony action on the client comprising analyzing 332 a client library and/or scanned storage for media of an active user, and building 333 a list of client playlists and a master list of client media content based on the analysis. The playlists comprises a name and a list of media content. The method for running 331 an aggregation synchrony action further comprises loading 334 a server library holding a server media list of all media content on the server, and retrieving 335 a list of playlists currently on the server. For each playlist in the list of client playlists 336, the playlist is added 338 to a copy list unless the client playlist is present on a server playlist and the client and server playlists are the same 337. For each playlist in a list of server playlists 339, the playlist is added 341 to a delete list unless the copy list has a client playlist corresponding to the playlist 340. For each media file in the master list of client media content 342, the media file is copied 344 to the server unless the media file is already in the server media content list and a lower quality version than the media file in the server media list 343, and the media file is added 345 to a server library. For each playlist in the delete list 346, the playlist is deleted 347 from the server. For each playlist in the copy list 348, the play list is written 349 to the server. The server library is then written 350.

Referring to FIG. 3E, in some embodiments an aspect 360 of the computer-executed method for handling media content can include building 361 the list of client playlists and a master list of client media content comprising building 362 the master list of client media content by setting 363 an identifier and a filename for the individual media files. The method 360 further comprises sequencing 364 through a list of user-created client playlists by adding 365 each playlist in the list of user-created client playlists to a client-associated list of playlists.

Referring to FIG. 3F, in some embodiments an aspect 370 of the computer-executed method for handling playlist media content addresses handling of playlists. For each playlist in the list of client playlists 371, the computer-executed method 370 can comprise determining 372 whether the playlist is present on the server playlist. If the playlist is present on the server playlist 373, client playlist contents are compared 374 with the server playlist. If the client and server playlists are different 375, the client playlist is added 376 to the copy list. If the client and server playlists are not different 375, a playlist in the server playlist is marked 377 corresponding to the client playlist as a keeper. If the playlist is not present on the server playlist 373, the client playlist is added 378 to the copy list.

In some embodiments, for each playlist in the list of server playlists 381, if the server playlist does not have a keeper set 382, the playlist can be added 383 to the delete list.

In some embodiments, for each playlist in the copy list 384 and for each entry in the playlist 385, a destination for the entry is determined 386 and a path to the destination corresponding to entry name is modified 387. For each playlist in the copy list 384, a playlist file is written 388 to the server.

Referring to FIG. 3G, in some embodiments an aspect 390 of the computer-executed method for handling playlist media content addresses handling of media files. For each media file in the list of client media files 391, if the media file is in the server media file list 392 and a client date stamp for the media file is newer than a server date stamp 393, a destination is determined 394 and the media file is copied 395 from the client to the destination. If the media file is not in the server media file list 392, the destination is determined 394, the media file is copied 395 from the client to the destination, and the media file is added 396 to the server library.

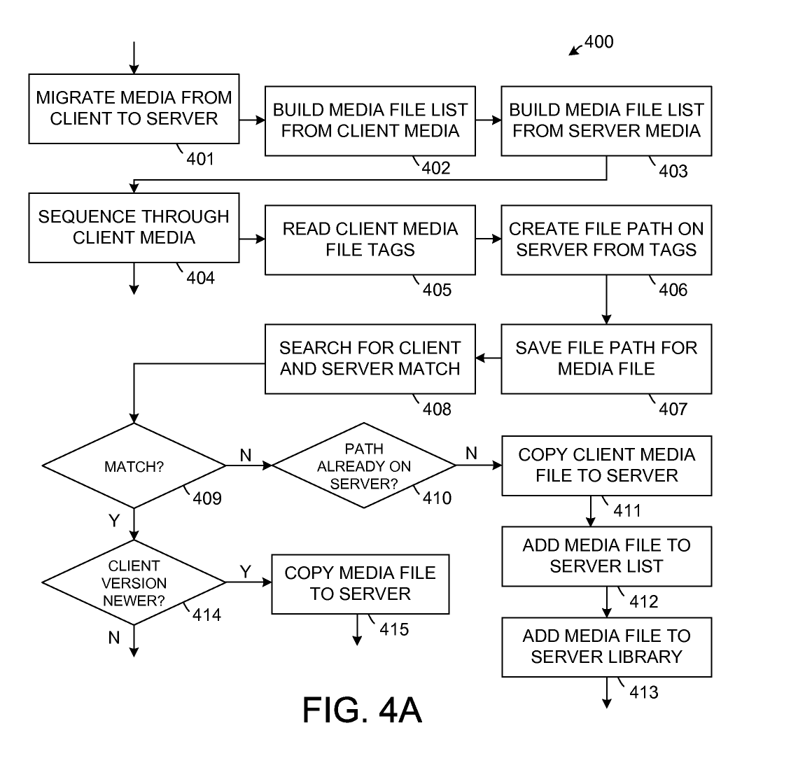

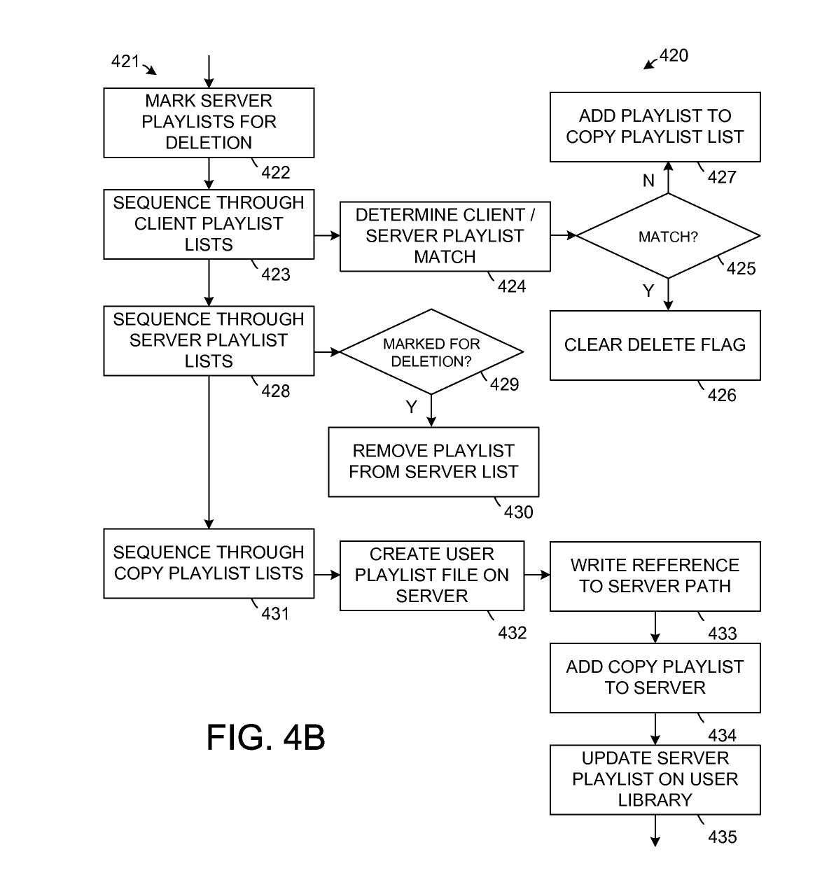

Referring to FIGS. 4A and 4B, flow charts illustrate one or more embodiments or aspects of a computer-executed method for handling 400 media content. In an example implementation, a server can have both a shared music folder, for example \\server\Music\, and share folders for each user, such as \\server\Users\user name. The shared music folder is used to store media files, for example tracks, organized in folders by artist and album name. Therefore, tracks for “Revolver” by the Beatles can be stored under \\server\Music\Beatles\Revolver\. User share folders include a Music subdirectory where a music library file is stored, along with personal play lists.

Migrating the user's media data from the client computer can be performed by copying tracks that are referenced in the user's media library, for example iTunes' “iTunes Music Library.xml” file, to the server, copying the user's playlists to the server, and updating the user's media library on the server to reflect the copy operation. At the same time, duplicate media files are resolved and only a single copy is copied to the global track library under \\server\Music.

Media files usually have some tag information embedded within the file which identifies meta information about the track. For example, ID3v2.2 tags are used in MP3 files. The tags indicate the Artist and Album information used by the process.

FIG. 4A shows a computer-executed method for migrating 401 media files from the client to the server comprising building 402 a list of media files and a list of playlists that are either present in a user music library and/or can be accessed by scanning from storage on the client, building 403 a list of media files and a list of playlists present in a server version of the user music library, and sequencing 404 through a client media file list for each of multiple client media files. Sequencing 404 through the client media file list comprises reading 405 tags of a client media file, creating 406 a file path on the server for the client media file based on the tags, saving 407 the file path for the media file in a media file object, and searching 408 a server media file list for a match with the client media file wherein a media file with a computed server path exists in the server media file list. For example, in a system that stores music files, the client media file is read 405 to access music tags, such as artist and album tag, the computed server path is saved 407 for the track in the track object, and the server track list is searched 408 for a match with the client track, for example a track with the computed server track exists in the server track list.

If no match occurs 409, the client media file is copied 411 to the server at the computed path unless the computed path already exists on the server 410, and the media file is added 412 to the server media file list whereby the media file is added 413 to a storage library for the user. If the client media file is a higher quality version than a matching server media file 414, the client media file is copied 415 to the server at the computed path.

For the example of a music system, without a match 409, if the server already has a file at the computed server path but the client file is higher quality, then the client file is copied to the server at the computed path. If the server does not have a file already 410, the client file is copied to the server at the computed path. The track is added 413 to a server track list so that the track is entered in the user's server library. If the client track is higher quality 414 than the matching server track, the client file is copied 415 to the server at the computed path.

Referring to FIG. 4B, a computer-executed method 420 for migrating 421 media files from the client to the server further comprises marking 422 each server playlist for deletion for example by setting a delete flag, and sequencing 423 through a client playlist list for each of multiple client playlists. Sequencing 423 through the client playlist list comprises determining 424 whether the client playlist matches an existing server playlist wherein names match and media file lists have the same length and contain same media files in same order. In a music system application, the playlist matches an existing server playlist when the names match and the tracklists are the same length and contain the same tracks in the same order. For a match 425, a delete flag is cleared 426 for an entry of the server playlist corresponding to the client playlist. For no match 425, the client playlist is added 427 to a copy playlist list. Migrating 421 media files from the client to the server further comprises sequencing 428 through a server playlist list for each of multiple server playlists. Sequencing 428 through a server playlist list comprises, if the playlist is marked for deletion 429, removing 430 the playlist from the server playlist list. Migrating 421 media files from the client to the server further comprises sequencing 431 through the copy playlist list for each of multiple copy playlists. Sequencing 431 through the copy playlist list comprises creating 432 a playlist file in a user's share on the server. An example playlist file on the server can be \\server\Users\user name\playlist.m3u. For each entry in the copy playlist 431, a reference is written 433 using the computed server path. The copy playlist is added 434 to the server playlist list and a user's music library is updated 435 on the server with a current version of the server media file list and the server playlist list.

Example data structures for music media can include, for a track, file name, file path for placing the file on the server, and an original file path for placing the file on the client.

Data structures for a playlist can include a playlist name, a deletion flag which is typically used only for server playlists, and a list of track objects.

The illustrative approach enables a global view of media files on the server where disk space is optimized because duplicate files do not coexist. More specifically, the user doesn't see any duplicate entries in the global view, even if multiple users have the same media file in associated user libraries, whether or note on the same client.

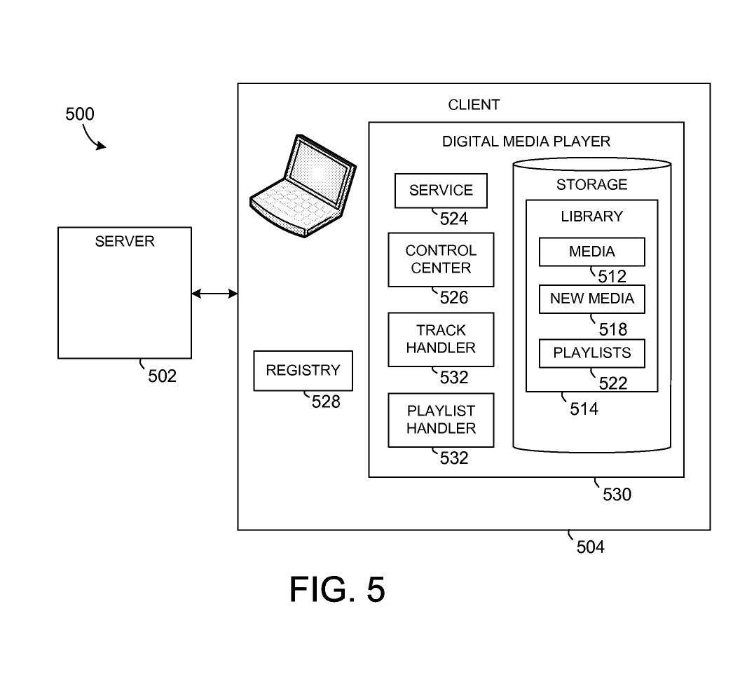

Referring to FIG. 5, a schematic block diagram depicts an embodiment of a media aggregation system 500. The illustrative example enables media aggregation for iTunes, a digital media player 530 made available by Apple, Inc., for playing and organizing digital music and video files. The illustrative system includes a feature that receives iTunes media files 512 and playlists 522 from clients systems 504 and copies the files and playlists to the server 502. MT-DAAP/Firefly is thus enabled to serve the files from a MediaSmart Server. The program code for the feature can execute as a service 524 on the client system 504, periodically checking for new files 518 and copying the new files 518 when detected.

In an example configuration, a user can configure iTunes aggregation using a MediaSmart Server Control Center 526. The user can enable media aggregation, specify authentication information, and select how often the aggregation is executed, for example in a range from every five minutes to once per week, or other suitable frequency. During configuration, the synchronization code can obtain the server name from the registry 528.

In an example file interaction, on the client side 504, the code can read the user's iTunes library file, “Documents and Settings”\<user_name>\“My Documents”\“My Music”\“iTunes”\“iTunes Music Library.xml”. The eXtensible Markup Language (XML) file lists the tracks and play lists that iTunes can perform. On the server side 502, the code creates and maintains a file, Library.xml. The file lists the tracks and play lists that have been loaded onto the server for the particular user. If the Library.xml file is missing, the synchronization creates the file and performs a normal synchronization assuming that no media is currently stored on the server for the user, which may result in files being copied over unnecessarily. If the Library.xml file is out of synchrony and lists items that don't exist or is missing items that should be present, the library file returns to synchrony once the synchronization runs. File interaction with the server 502 such as Library.xml file access, media file synchronization, and the like can be performed using Samba, a networking protocol that sets up network shares for selected directories.

In a synchronization operation can be performed each time the aggregation application runs on the client 504. Synchronization operates to synchronize the server 502 with contents of the user's iTunes library 514. In an illustrative embodiment, only media within the iTunes library 514 is synchronized. Other files are ignored.

An example embodiment of the media aggregation system 500 can perform track handling and playlist handling. In a track handler 532, if a particular track is contained within the client iTunes library 514 but is not on the server 502 (specifically, not in the Library.xml file), the track is copied to the server 502. If a particular track is present on the server 502 but is not in the client iTunes library 514, no change is made to the server 502 or the client 504. If a particular track is present on both the client iTunes library 514 and the server 502, the track is only copied if the client version is higher quality. In summary, tracks are copied to the server 502 if missing or lower quality than the client version and tracks are never removed from the server 502.

Tracks can be stored at \\<servername>\Music\<client_name>\ <client path to track>\<track_name>. Client_name refers to the name of the client system undergoing synchronization. “Client path to track” is the full path to the track on the client system with the drive letter as a path element, for example \C\Documents and Settings\fahren\My Documents\My Music\user name). The approach for storing track files on the server 502 enables the server 502 to share track files if the files are shared on the client system, for example two users have the same track file loaded into separate libraries associated with the users. The single file is stored on the server 502, rather than presence of two copies.

In a playlist handler 534, aggregation can be limited to playlists so that default play lists (“90's Music”, “Music”, and the like) and smart playlists are ignored. If a playlist is defined in the client iTunes library 514, but does not exist on the server 502, for instance is not in the Library.xml file, then the playlist is copied to the server 502. If a playlist is defined on the server 502 but does not exist in the client iTunes library 514, the playlist is deleted from the server 502. If a playlist exists on both the server 502 and the client iTunes library 514, then the playlist is copied to the server 502 if the playlist content is different on the client 504. In summary, playlists on the server 502 are made to reflect the current set of playlists on the client 504.

Playlists can be stored as m3u files at \\<server_name>\Music\<client_name>\<user_name>\<playlist_name>.m3u. Client_name refers to the name of the client system that is synchronized. User_name is the users login. Playlist_name is the name of the play list in the iTunes library 514.

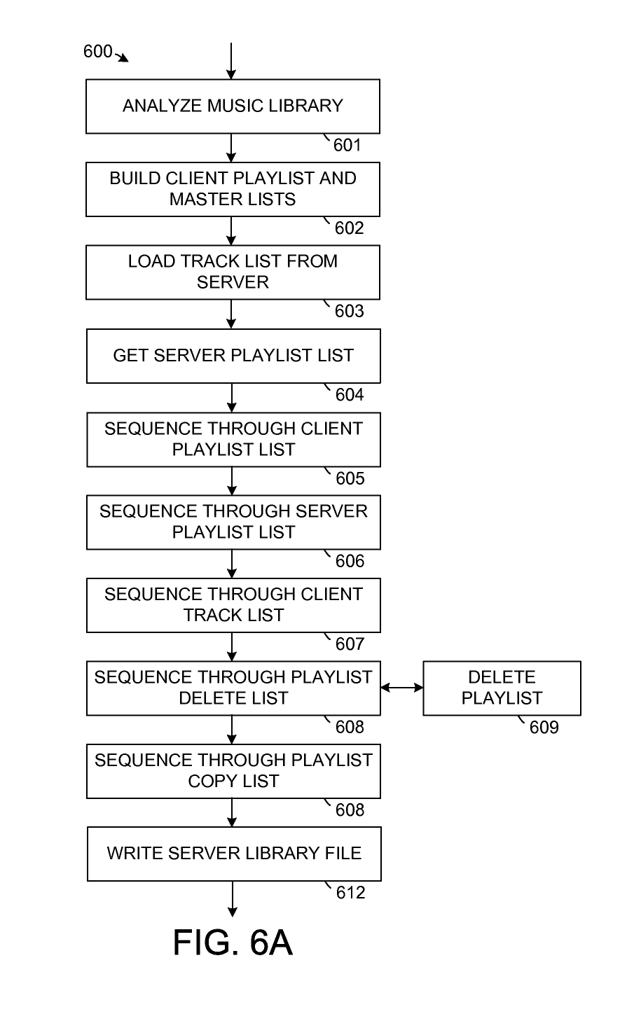

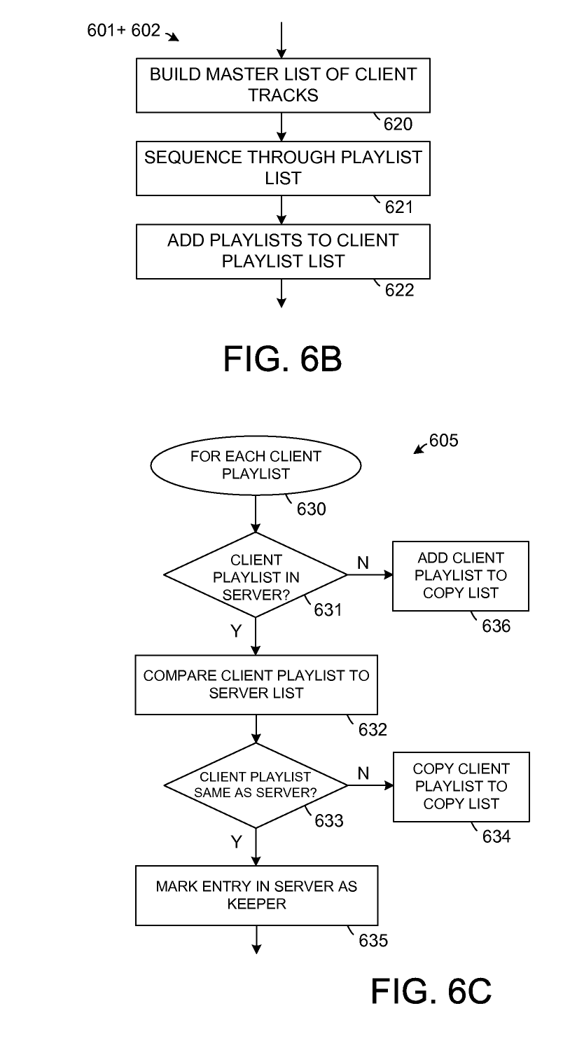

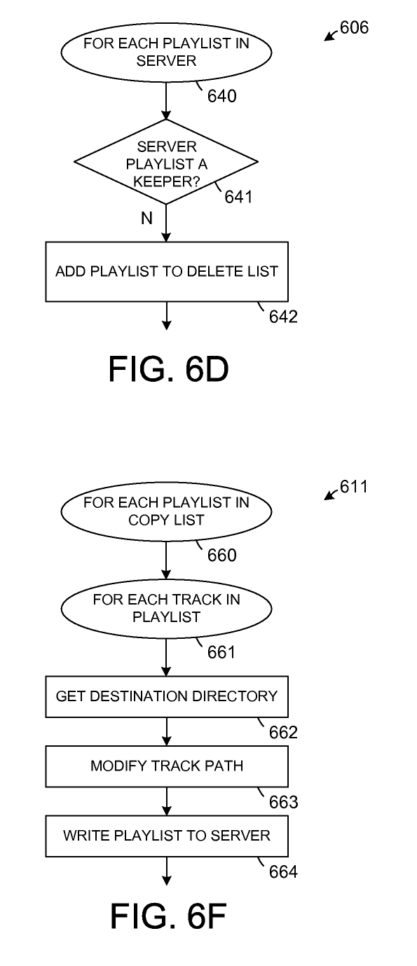

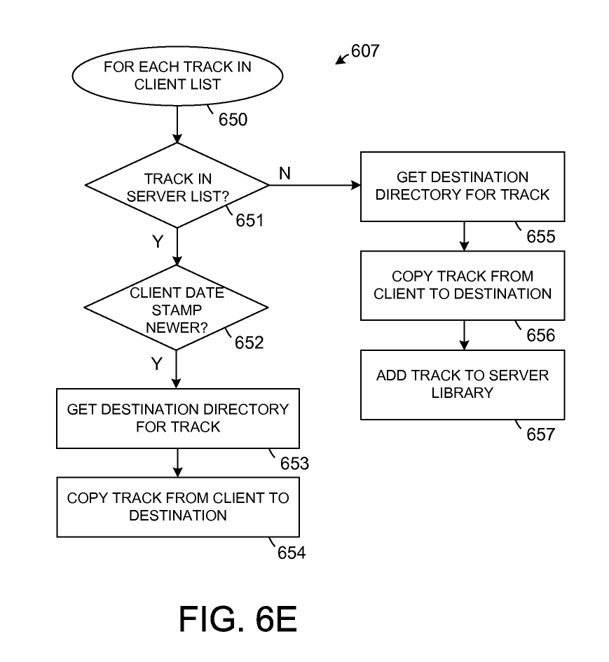

Referring to FIGS. 6A through 6F, flow charts illustrate one or more embodiments or aspects of a computer-executed method for executing aggregating synchronization on a client. FIG. 6A shows the aggregating synchronization method 600 comprising analyzing 601 the active user's iTunes library file, for example “Documents and Settings”\<user_name>\“My Documents”\“My Music”\“iTunes”\“iTunes Music Library.xml,” and building 602 a list of client playlists and a master list of client tracks.

Referring to FIG. 6B, analyzing 601 and building 602 the client playlists and master list of tracks can comprise building 620 the master list of client tracks, forming a track list in which each track has an identifier (ID) and a filename. Analyzing and building the lists can further comprise sequencing 621 through the list of playlists, and adding 622 each playlist to the list of playlists for the client. In an example implementation, a Library playlist can be detected using a “Master” key value and is always renamed “Library” regardless of location, and, if detected, the operation of copying the library playlist can be omitted. In the list of playlists, each playlist can include a name and a list of tracks.

Referring again to FIG. 6A, the method 600 can further comprise loading 603 the file containing a list of all tracks on the server, for example \\<server_name>\Music\<client_name>\<user_name>\Library.xml ( ) obtaining 604 a list of playlists currently on the server, for instance (\\<server_name>\Music\<client_name>\<username>\*.m3u), and sequencing 605 through the playlists in the client playlist list, sequencing 606 through the playlists in the server playlist list, and sequencing 607 through the tracks in a client track list.

Referring to FIG. 6C, sequencing 605 through the playlists in the client playlist list can comprise, for each playlist 630 in client playlist list, if a client playlist is present 631 in server list, the client playlist contents are compared 632 with server play list. If the playlists are different 633, the client playlist is copied 634 to a copy list, thereby causing the playlist on the server to be updated. If the playlists are the same 633, the entry in server list is marked 635 as “keeper”, for example by a “keeper flag”. If the client playlist is not present 631 in the server list, the client playlist is added 636 to the copy list.

Referring to FIG. 6D, sequencing 606 through the playlists in the server playlist list can comprise, for each playlist 640 in server playlist list, if server playlist does not include 641 a “keeper flag” set, then the playlist is added 642 to a delete list.

Referring to FIG. 6E, sequencing 607 through the tracks in a client track list can comprise, for each track 650 in the client track list, if the track is in server track list 651 and a client date stamp is higher quality 652 than a server date stamp, then a destination directory (dest_dir) is obtained 653 for the track, for example \\<servername>\Music\<client_name>\<client path to track>\<track_name>, and the track is copied 654 from the client to the destination directory (dest_dir). If the track is not in the server track list 651, the destination directory (dest_dir) is obtained 655 for the track, the track is copied 656 from client to the destination directory (dest_dir), and the track is added 657 to server library xml.

Referring again to FIG. 6A, the method 600 can further comprise sequencing 608 through the playlists in the delete list including, for each playlist in the delete list 608, deleting 609 the playlist from the server. The method 600 also comprises sequencing 610 through the playlists in the copy list.

Referring to FIG. 6F, sequencing 611 through the playlists in the copy list can comprise, for each playlist in the copy list 660, for each track 661 in playlist, the destination directory (dest_dir) is obtained 662 for track, and the track path is modified 663 to dest_dir\track_name. The playlist file is written 664 to the server.

Referring again to FIG. 6A, the method 600 can further comprise writing 611 the server library xml file.

Terms “substantially”, “essentially”, or “approximately”, that may be used herein, relate to an industry-accepted tolerance to the corresponding term. Such an industry-accepted tolerance ranges from less than one percent to twenty percent and corresponds to, but is not limited to, functionality, values, process variations, sizes, operating speeds, and the like. The term “coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. Inferred coupling, for example where one element is coupled to another element by inference, includes direct and indirect coupling between two elements in the same manner as “coupled”.

The illustrative block diagrams and flow charts depict process steps or blocks that may represent modules, segments, or portions of code that include one or more executable instructions for implementing specific logical functions or steps in the process. Although the particular examples illustrate specific process steps or acts, many alternative implementations are possible and commonly made by simple design choice. Acts and steps may be executed in different order from the specific description herein, based on considerations of function, purpose, conformance to standard, legacy structure, and the like.

The block diagrams and flow charts further describe an article of manufacture comprising a controller-usable medium having a computer readable program code embodied in a controller for handling media content and aggregating media content from a client of a plurality of clients onto a server.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the following claims.

What is claimed is:

1. A computer-executed method for handling media content comprising:
aggregating media content from a client of a plurality of clients onto a server comprising:
periodically checking for media that is newly added in a client library or scanned from client storage of the client plurality;
detecting newly added media;
determining whether the newly added media is present on the server;
if the newly added media is not present on the server, copying the newly added media to the server;
if the newly added media is present on the server, determining whether the newly added media is a higher quality version in comparison to media on the server; and
if the newly added media is a higher quality version, copying the higher quality version media to the server.

2. The method according to claim 1 further comprising:
aggregating media content on the client plurality comprising:
reading a user's client library that lists media files and playlists.

3. The method according to claim 1 further comprising:
aggregating media content on the client plurality comprising:
scanning for content on a computer.

4. The method according to claim 1 further comprising:
synchronizing the server comprising:
determining presence of a media file on the server;
if the media file is not present, creating the media file that lists media and playlists which are loaded onto the server;
copying media from the client to the server for media that are missing or lower quality version than media from the client; and
saving the media file.

5. The method according to claim 1 further comprising:
aggregating playlists from the client of a plurality of clients onto the server comprising:
for playlists existing in the client library and/or scanned from client storage that do not exist on the server, copying the client playlist to the server;
for playlists existing on the server that do not exist in the client library and/or scanned from client storage, deleting the playlist from the server;
for playlists existing on the server and in the client library and/or scanned from client storage, determining whether playlist content is different on the server and in the client library and/or scanned from client storage; and
if the playlist content on the server and the client library and/or scanned from client storage are different, copying the playlist content from the client library and/or scanned from client storage to the server.

6. The method according to claim 1 further comprising:
running an aggregation synchrony action on the client comprising:
analyzing a client library and/or scanned storage for media of an active user;
building a list of client playlists and a master list of client media content based on the analysis, the playlists comprising a name and a list of media content;
loading a server library holding a server media list of all media content on the server;
retrieving a list of playlists currently on the server;
for each playlist in the list of client playlists, adding the playlist to a copy list unless the client playlist is present on a server playlist and the client and server playlists are the same;
for each playlist in a list of server playlists, adding the playlist to a delete list unless the copy list has a client playlist corresponding to the playlist;
for each media file in the master list of client media content, copying the media file to the server unless the media file is already in the server media content list and a lower quality version than the media file in the server media list, and adding the media file to a server library;
for each playlist in the delete list, deleting the playlist from the server;
for each playlist in the copy list, writing the play list to the server; and
writing the server library.

7. The method according to claim 6 further comprising:
building the list of client playlists and a master list of client media content comprising:
building the master list of client media content comprising setting an identifier and a filename for the individual media files; and
sequencing through a list of client playlists comprising:
adding each playlist in the list of client playlists to a client-associated list of playlists.

8. The method according to claim 6 further comprising:
for each playlist in the list of client playlists:
determining whether the playlist is present on the server playlist;
if the playlist is present on the server playlist:
comparing client playlist contents with the server playlist;
if the client and server playlists are different, adding the client playlist to the copy list; and
if the client and server playlists are different, marking a playlist in the server playlist corresponding to the client playlist as a keeper;
if the playlist is not present on the server playlist:
adding the client playlist to the copy list.

9. The method according to claim 8 further comprising:
for each playlist in the list of server playlists:
if the server playlist does not have a keeper set, adding the playlist to the delete list.

10. The method according to claim 6 further comprising:
for each media file in the list of client media files:
if the media file is in the server media file list:
if a client date stamp for the media file is newer than a server date stamp, determining a destination and copying the media file from the client to the destination;
if the media file is not in the server media file list:
determining the destination, copying the media file from the client to the destination, and adding the media file to the server library.

11. The method according to claim 6 further comprising:
for each playlist in the copy list:
for each entry in the playlist, determining a destination for the entry and modifying a path to the destination corresponding to entry name; and
writing a playlist file to the server.

12. The method according to claim 1 further comprising:
migrating media files from the client to the server comprising:
building a list of media files and a list of playlists present in a user music library and/or scanned from storage on the client;
building a list of media files and a list of playlists present in a server version of the user music library;
sequencing through a client media file list for each of a plurality of client media files comprising:
reading music tags of a client media file;
creating a file path on the server for the client media file based on the music tags;
saving the file path for the media file in a media file object;
searching a server media file list for a match with the client media file wherein a media file with a computed server path exists in the server media file list;
if no match occurs, copying the client media file to the server at the computed path unless the computed path already exists on the server, and adding the media file to the server media file list whereby the media file is added to a storage library for the user;
if the client media file is a higher quality version than a matching server media file, copying the client media file to the server at the computed path.

13. The method according to claim 12 further comprising:
migrating media files from the client to the server further comprising:
marking each server playlist for deletion;
sequencing through a client playlist list for each of a plurality of client playlists comprising:
determining whether the client playlist matches an existing server playlist wherein names match and media file lists have the same length and contain same media files in same order;
for a match, clearing a delete flag for an entry of the server playlist corresponding to the client playlist; and
for no match, adding the client playlist to a copy playlist list;
sequencing through a server playlist list for each of a plurality of server playlists comprising:
if the playlist is marked for deletion, removing the playlist from the server playlist list;
sequencing through the copy playlist list for each of a plurality of copy playlists comprising:
creating a playlist file in a user's share on the server;
for each entry in the copy playlist, writing a reference using the computed server path; and
adding the copy playlist to the server playlist list; and
updating a user's music library on the server with a current version of the server media file list and the server playlist list.

14. A data processing system comprising:
a media manager that aggregates media content from a client of a plurality of clients onto a server comprising:
a monitoring utility that periodically checks for media files that are newly added in a client library of the client plurality and/or scanned from client storage, and detects newly added media; and
a server media update utility that determines whether the newly added media is present on the server and copies the newly added media to the server if the newly added media is not present on the server or a lower quality version of the newly added media is present on the server.

15. The system according to claim 14 further comprising:
the media manager executable on the client of a plurality of clients.

16. The system according to claim 14 further comprising:
the media manager executable on the server.

17. The system according to claim 14 further comprising:
the media manager executable in part on the client of a plurality of clients and executable in part on the server.

18. The system according to claim 14 further comprising:
a network;
a server coupled to the network; and
at least one client coupled to the network, the server at at least one client configured to run the media manager.

19. An article of manufacture comprising:
a controller-usable medium having a computer readable program code embodied in a controller for handling media content and aggregating media content from a client of a plurality of clients onto a server, the computer readable program code further comprising:
code causing the controller to periodically check for media that is newly added in a client library or scanned from client storage of the client plurality;
code causing the controller to detect newly added media;
code causing the controller to determine whether the newly added media is present on the server;
code causing the controller to copy the newly added media to the server if the newly added media is not present on the server;
code causing the controller to determine whether the newly added media is a higher quality version in comparison to media on the server if the newly added media is present on the server; and
code causing the controller to copy the higher quality version media to the server if the newly added media is a higher
